(19) United States
(12) Patent Application Publication
(10) Pub. No.: US 2013/0006821 A1
(43) Pub. Date: Jan. 3, 2013

(54) SYSTEMS AND METHODS FOR IMPORTING ITEMS

(75) Inventors: John Pirrello, Cumming, GA (US); Stuart Marcus, Atlanta, GA (US); John R. Slayton, Atlanta, GA (US); Robert L. Klingenberg, Atlanta, GA (US)

(73) Assignee: UNITED PARCEL SERVICE OF AMERICA, INC., Atlanta, GA (US)

(21) Appl. No.: 13/537,613

(22) Filed: Jun. 29, 2012

Related U.S. Application Data
(60) Provisional application No. 61/503,399, filed on Jun. 30, 2011.

(51) Int. Cl. G06Q 50/28; G06Q 30/04

(52) U.S. Cl. 705/34; 705/331

(57) ABSTRACT

Various embodiments of the present invention provide improved systems, methods and computer program products for managing the delivery of items across international borders. Systems and methods for facilitating an international cross-border shipment from an exporting entity to an import entity are provided. The method may include the steps of: receiving, via an import computer system, shipping data comprising a pickup location and a delivery location corresponding to an item to be delivered from an export entity to an import entity; providing an interactive display offering a plurality of label delivery options to an import entity; receiving a selection from the import entity of a select label delivery option; generating a commercial invoice using at least in part the received shipping data; and providing a label and the commercial invoice according to the selected label delivery option

### CROSS-REFERENCE TO RELATED APPLICATIONS

This application claims the benefit and priority of U.S. Patent Application No. 61/503,399, filed on Jun. 30, 2011, which is incorporated herein by reference in its entirety.

### BACKGROUND

A challenge facing businesses and individuals seeking to purchase items from other countries is how to effectively transport their products over international borders and maintain control over sensitive information. Typically, the seller or exporter manages the delivery of the item and often charges additional fees for this service. Furthermore, discounts negotiated with delivery service companies by the import entity cannot be used without divulging confidential account information to a seller or exporter. Thus, a need in the industry exists for improved systems and methods for managing the delivery of items across international borders that allow a requestor, customer or importer to control aspects of the delivery process.

### BRIEF SUMMARY OF THE INVENTION

Various embodiments of the present invention provide improved systems, methods and computer program products for managing the delivery of items across international borders. In one aspect, a method for facilitating an international cross-border shipment from an export entity to an import entity is provided. This method includes the steps of: receiving, via an import computer system, shipping data comprising a pickup location and a delivery location corresponding to an item to be delivered from the export entity to the import entity; providing an interactive display to the import entity offering a plurality of label delivery options; receiving a selection from the import entity of a select label delivery option; generating a commercial invoice using at least in part the received shipping data; and providing a label and the commercial invoice according to the select label delivery option.

In another aspect of the invention, a system for facilitating an international cross-border shipment from an export entity to an import entity is provided. The system includes an import control system comprising one or more processors and one or more memory storage areas. The import control system is configured to: receive shipping data comprising a pickup location and a delivery location corresponding to an item to be delivered to from the export entity to the import entity; provide an interactive display to the import entity offering a plurality of label delivery options; receive a selection from the import entity of a select label delivery option; generate a commercial invoice using at least in part the received shipping data; and provide a label and the commercial invoice according to the selected label delivery option.

### BRIEF DESCRIPTION OF THE SEVERAL VIEWS OF THE DRAWING(S)

Reference will be made to the accompanying drawings, which are not necessarily drawn to scale, and wherein:

FIG. 1 is a diagram of a system that can be used to practice various embodiments of the present invention.

FIG. 2 is a schematic of an import control system in accordance with certain embodiments of the present invention.

FIG. 3 is a flowchart illustrating a process for controlling the importation of items in accordance with various embodiments of the present invention.

FIG. 4 is a flow chart illustrating a process for providing shipping documents and labels to an export entity in accordance with embodiments of the present invention.

FIGS. 5-14 show exemplary input and output of various embodiments of the present invention.

FIGS. 15-21 show exemplary input and output of additional embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. METHODS, APPARATUS, SYSTEMS, AND COMPUTER PROGRAM PRODUCTS

As should be appreciated, various embodiments may be implemented in various ways, including as methods, apparatus, systems, or computer program products. Accordingly, various embodiments may take the form of an entirely hardware embodiment or an embodiment in which a processor is programmed to perform certain steps. Furthermore, various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### II. EXEMPLARY SYSTEM ARCHITECTURE

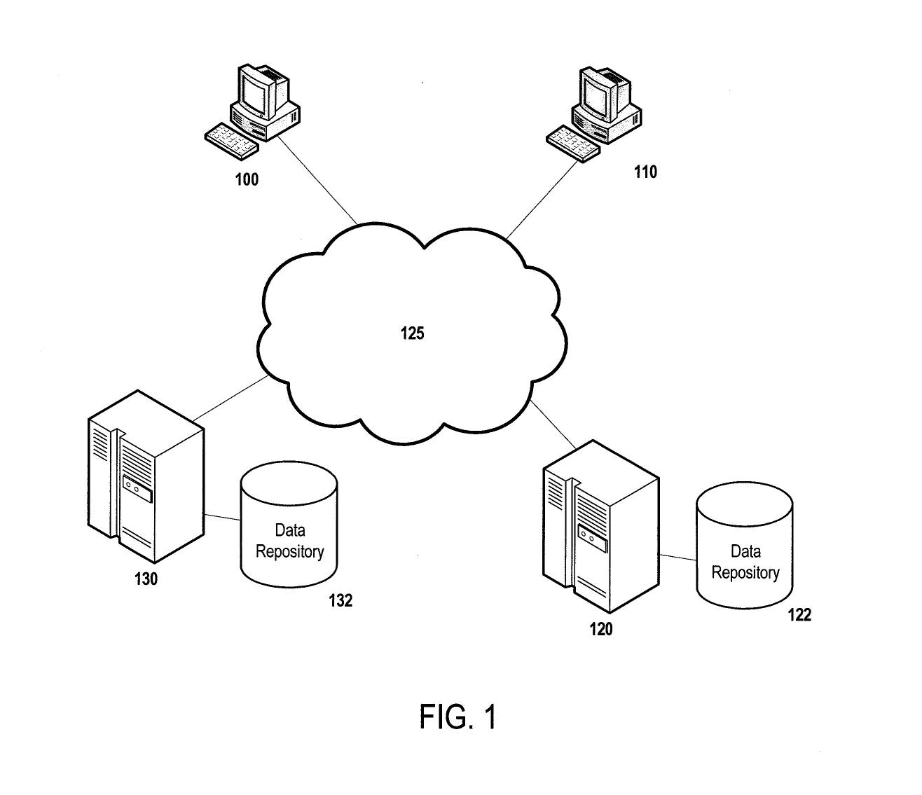

FIG. 1 provides an illustration of a system that can be used in conjunction with various embodiments of the present invention. As shown in FIG. 1, the system may include an import entity computer system 100, an export entity computer system 110, an import control system 120, a carrier system 130, and one or more networks 125. In various embodiments, the import control system 120 may be in communication with one or more types of storage media 122. In addition, the import control system 120 may include a database management system and the storage media 122 may include one or more databases and one or more database instances (also referred to herein as “data repository”). In various embodiments, the storage media 122 may be one or more types of medium such as hard disks, magnetic tapes, or flash memory. The term “database” refers to a structured collection of records or data that is stored in a computer system, such as via a relational database, hierarchical database, or network database. Similarly, the carrier system 130 may be in communication with one or more types of storage media 132 (also referred to herein as a “data repository”) having similar functionality to the storage media 122.

Each of the components of the system may be in electronic communication with, for example, one another over the same or different wireless or wired networks including, for example, a wired or wireless Personal Area Network (PAN), Local Area Network (LAN), Metropolitan Area Network (MAN), Wide Area Network (WAN), or the like. Additionally, while FIG. 1 illustrates certain system entities as separate, standalone entities, the various embodiments are not limited to this particular architecture.

a. Exemplary Import Control System

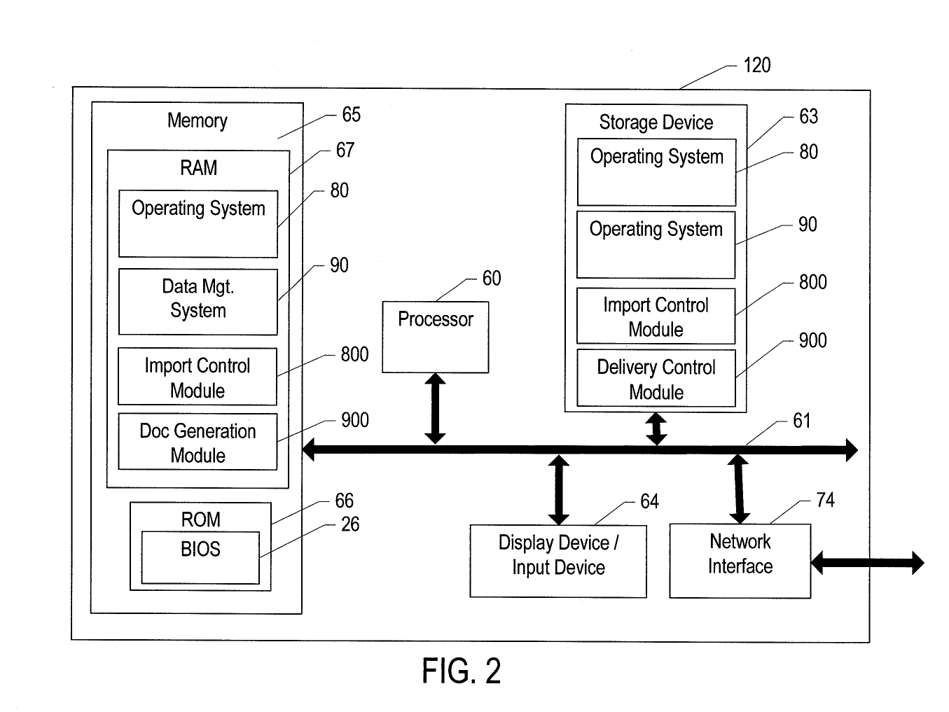

FIG. 2 provides a schematic of an import control system 120 according to one embodiment of the present invention. In general, the import control system 120 may refer to, for example, any computer, computing device, mobile phone, desktop, notebook or laptop, distributed system, server, blade, gateway, switch, processing device, or combination of processing devices adapted to perform the functions described herein. However, the import control system 120 may also comprise various other systems and their corresponding components.

As will be understood from this figure, in one embodiment, the import control system 120 may include a processor 60 that communicates with other elements within the import control system 120 via a system interface or bus 61. The processor 60 may be embodied in a number of different ways. For example, the processor 60 may be embodied as one or more processing elements, one or more microprocessors with accompanying digital signal processors, one or more processors without an accompanying digital signal processors, one or more coprocessors, one or more multi-core processors, one or more controllers, and/or various other processing devices including integrated circuits such as, for example, an application specific integrated circuit (ASIC), a field programmable gate array (FPGA), a hardware accelerator, and/or the like.

In an exemplary embodiment, the processor 60 may be configured to execute instructions stored in the device memory or otherwise accessible to the processor 60. As such, whether configured by hardware or software methods, or by a combination thereof, the processor 60 may represent an entity capable of performing operations according to embodiments of the present invention when configured accordingly. A display device/input device 64 for receiving and displaying data may also be included in or associated with the import control system 120. The display device/input device 64 may be, for example, a keyboard or pointing device that is used in combination with a monitor. The import control system 120 may further include transitory and non-transitory memory, which may include both random access memory (RAM) 67 and read only memory (ROM) 65. The server's ROM 65 may be used to store a basic input/output system (BIOS) 26 containing the basic routines that help to transfer information to the different elements within the import control system 120.

In addition, in one embodiment, the import control system 120 may include at least one storage device 63, such as a hard disk drive, a CD drive, a DVD drive, and/or an optical disk drive for storing information on various computer-readable media. The storage device(s) 63 and its associated computer-readable media may provide nonvolatile storage. The computer-readable media described above could be replaced by any other type of computer-readable media, such as embedded or removable multimedia memory cards (MMCs), secure digital (SD) memory cards, Memory Sticks, electrically erasable programmable read-only memory (EEPROM), flash memory, hard disk, and/or the like. Additionally, each of these storage devices 63 may be connected to the system bus 61 by an appropriate interface.

Furthermore, a number of program modules may be stored by the various storage devices 63 and/or within RAM 67. Such program modules may include an operating system 80, database management system 90, and an Import Control Module 800 and a Document Generation Module 900. As discussed in greater detail below, these modules may control certain aspects of the operation of the import control system 120 with the assistance of the processor 60 and operating system 80, although their functionality need not be modularized. In addition to the program modules, the import control system 120 may store and/or be in communication with one or more databases.

Also located within and/or associated with the import control system 120, in one embodiment, is a network interface 74 for interfacing with various computing entities. This communication may be via the same or different wired or wireless networks (or a combination of wired and wireless networks), as discussed above. For instance, the communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), and/or any other wired transmission protocol. Similarly, the import control system 120 may be configured to communicate via wireless external communication networks using any of a variety of protocols, such as 802.11, GPRS, UMTS, CDMA2000, WCDMA, TD-SCDMA, LTE, E-UTRAN, Wi-Fi, WiMAX, UWB, and/or any other wireless protocol.

It will be appreciated that import control system's 120 components may be located remotely from other import control system 120 components. Furthermore, one or more of the components may be combined and additional components performing functions described herein may be included in the import control system 120.

b. Carrier System

The carrier system 130 may include one or more components that are functionally similar to those of the import control system 120. For example, in one embodiment, the computing devices include (a) a processor that communicates with other elements via a system interface or bus, (b) a display device/input device; (c) memory including both RPM and RAM; (d) a storage device; and a network interface. These architectures are provided for exemplary purposes only and are not limiting to the various embodiments. The term “computing device” is used generically to refer to any computer, mobile phone, computing device, desktop, notebook or laptop, distributed system, server, gateway, switch, or other processing device adapted to perform the functions described herein.

c. Exemplary Import/Export Computing Devices

The import computing devices and the export computing devices may each include one or more components that are functionally similar to those of the import control system 120. For example, in one embodiment, the computing devices include (a) a processor that communicates with other elements via a system interface or bus, (b) a display device/input device; (c) memory including both RPM and RAM; (d) a storage device; and a network interface. These architectures are provided for exemplary purposes only and are not limiting to the various embodiments. The term “computing device” is used generically to refer to any computer, mobile phone, computing device, desktop, notebook or laptop, distributed system, server, gateway, switch, or other processing device adapted to perform the functions described herein.

### III. EXEMPLARY SYSTEM OPERATION

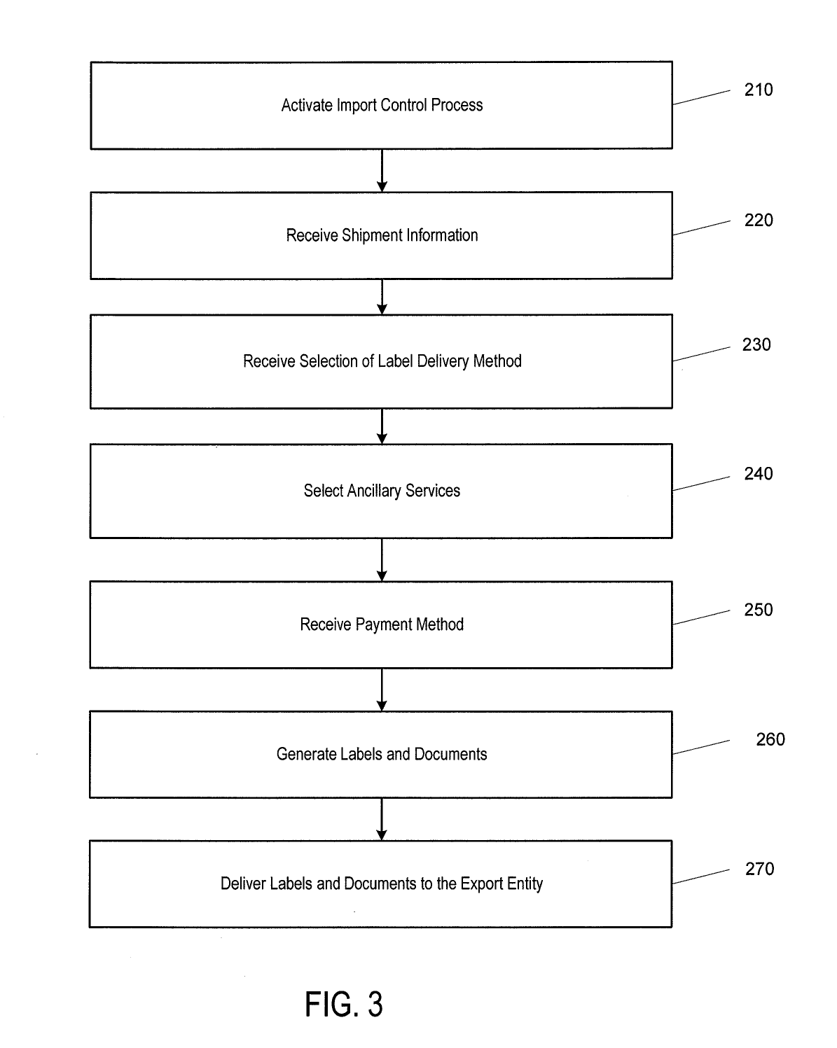

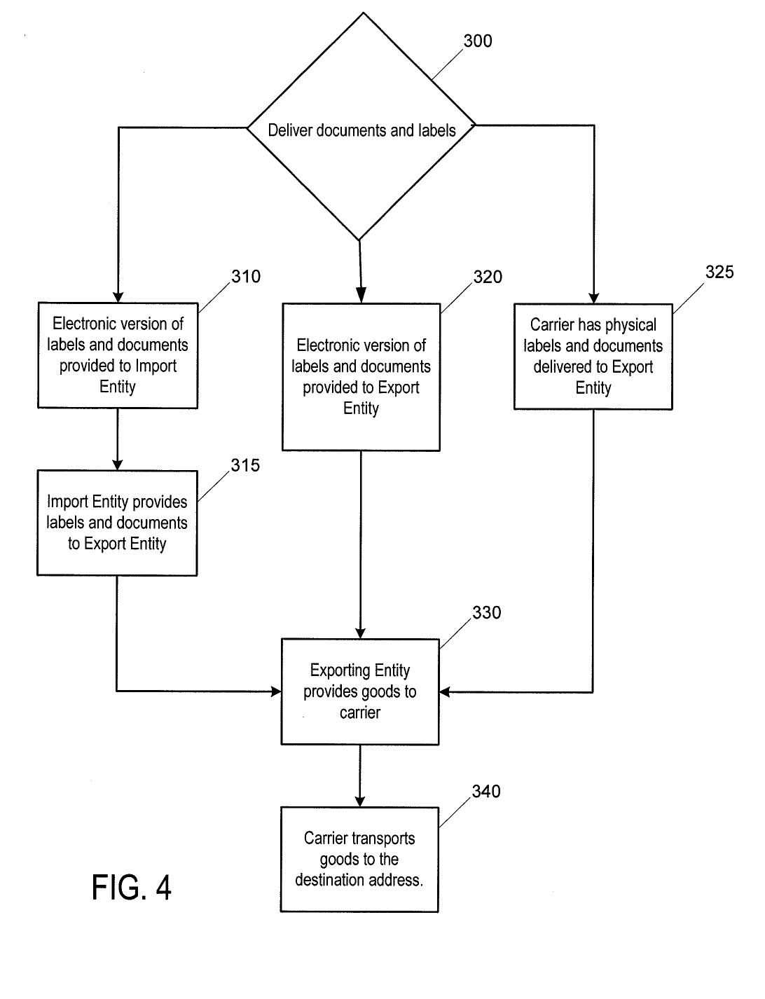

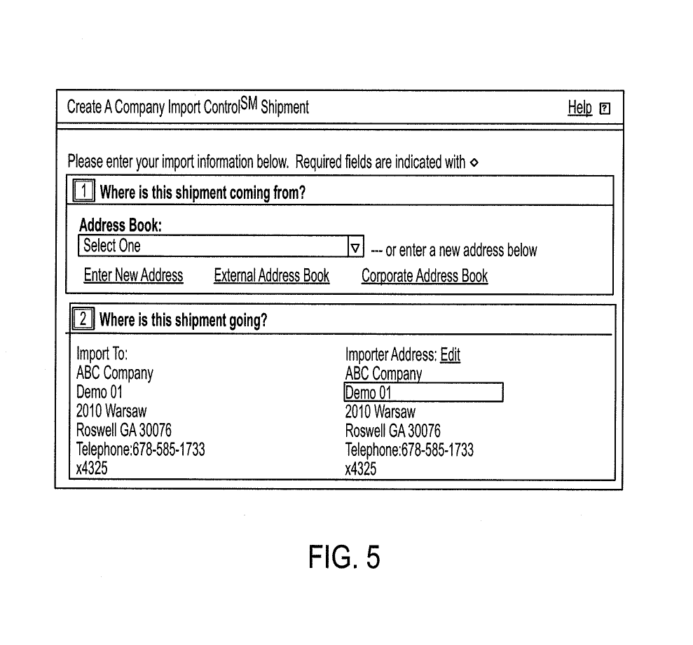

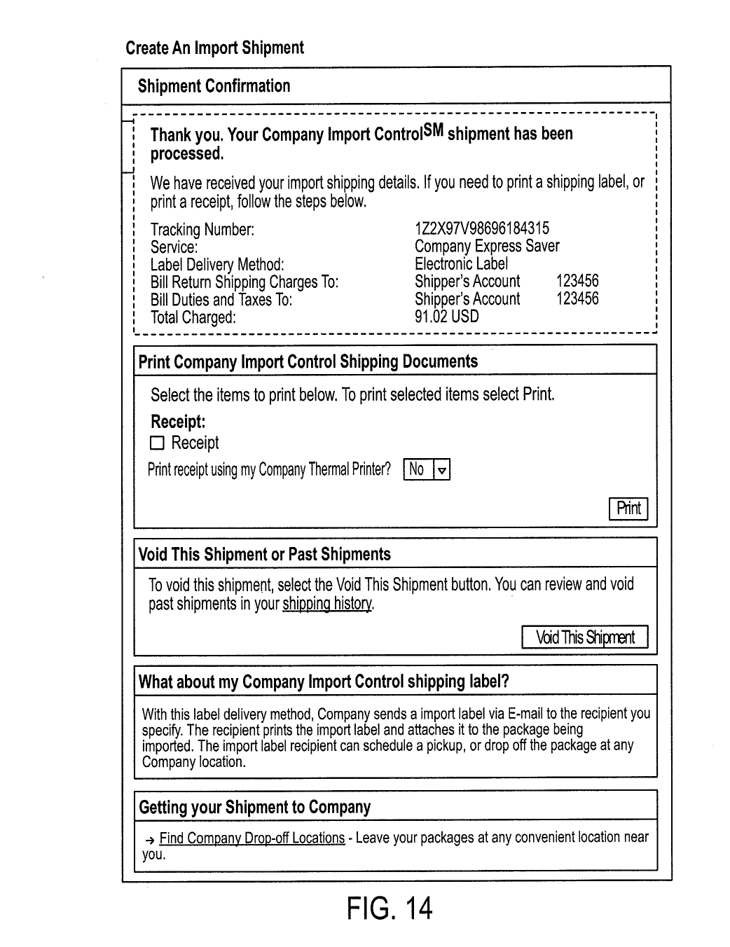

FIGS. 3 and 4 provide flow diagrams illustrating steps that may be performed by the import control system 120 in accordance various embodiments. FIGS. 5-14 and 15-21 illustrate exemplary embodiment of these steps in the form of interactive displays or webpages. Although the exemplary system architecture discussed above and illustrated in FIG. 1 shows the import control system 120 and the carrier system 130 as distinct systems, it should be understood that the functionality associated with the import control process as discussed below may be implemented in the import control system 120, the carrier system 130 or a combination of the two systems.

### a. Import Control Process

In one embodiment, as indicated at Block 210 of FIG. 3, the process beings with activation of the import control process by an import entity. The import entity may be an individual, a family, a company, an organization, an entity, a department within an organization, a representative of an organization and/or person, and/or the like. To activate the import control process, an import entity (e.g., an import entity or an import entity representative operating an import entity computing device 100) may access a webpage or portal of a carrier, such as United Parcel Service of America, Inc. (UPS) WorldShip™ or CampusShip™. For instance, the carrier's system 130 may transmit a webpage that provides the customer with an option of using the import control process by activating a button or other selection technique. In other embodiments, the carrier system 130 may recognize that shipment details being entered require delivery across an international border (e.g., by a comparison of the origin address and the destination address) and prompt the import entity to use the import control process. In still further embodiments, the import control system may be accessed directly from the import entity (e.g., an import entity or an import entity representative operating an import entity computing device 110 via the network 125).

After the import control process is activated, the import entity (e.g., an import entity or an import entity representative operating an import entity computing device 100) provides information about the international shipment (Block 220). The shipment information may include a pickup location and a destination location. In one embodiment, as shown in FIG. 5, the import entity is prompted (e.g., by the Import Control Module 800) to enter an origin address (e.g., “Where is the shipment coming from?”), a destination address (e.g., “Import to”) and the address of the import entity (e.g., “Importer Address”). In some instances, the import entity may purchase a product and have that product delivered to a different entity, and therefore the destination address and the address of the import entity may not be the same. Of course, in some instances the purchased item may be delivered to the import entity's address and thus the two addresses would be the same. After the information is entered, it may be stored in the data repository for later use in generating labels or other documents as described in greater detail below.

In one embodiment, as illustrated in FIG. 5, the origin address may be retrieved from an address book associated with the import entity that is stored in a data repository associated with the carrier system and/or the import control system. In the embodiment illustrated in FIG. 5, an address book may be accessed by using a drop down menu associated with the Address Book text box, activation of the “External Address Book” link or activation of the “Corporate Address Book” links. If the desired origin address is not present in the address book selected or there is no address book associated with the import entity, the import entity may enter the address manually. Of course, the import entity may manually enter an address as opposed to accessing an existing address book as desired.

Similarly, the import entity's address may also be stored in a data repository associated with the carrier system and/or the import control system. This data may be used to pre-populate both the destination address and the import entity's address information. In which case, the import entity may have been identified via a customer account number, password or log-in process as would be understood by those of skill in the art. The import control system may then allow the import entity to edit the addresses as necessary. In some embodiments, the import entity may be prompted to enter or select the destination and import entity addresses from an address book.

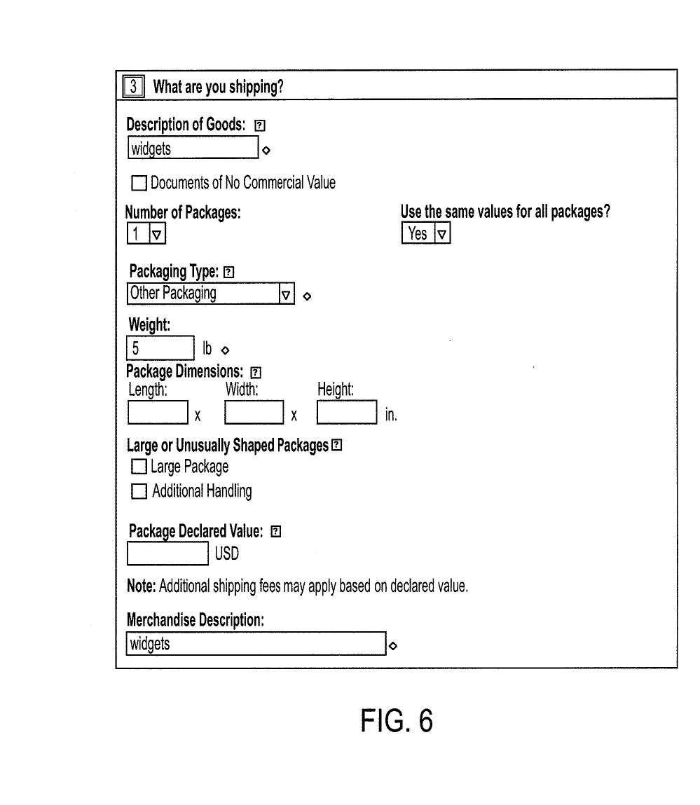

In addition, further shipment information regarding the items to be shipped may also be entered. This information may include a description of the items to be shipped, the number of packages, the weight and dimensions of the packages, the declared value and a merchandise description. For instance, as shown in FIG. 6, an import entity (e.g., an import entity or an import entity representative operating an import entity computing device 100) may be presented (e.g., by the Import Control Module 800) with a plurality of fields prompting the import entity to enter various information regarding the items/packages to be shipped.

After the shipment information is entered, the import entity (e.g., an import entity or an import entity representative operating an import entity computing device 100) may select a service level for the shipment and additional ancillary delivery services as desired. For instance, as shown in FIG. 6, the import entity may be presented (e.g., by the Import Control Module 800) with a dropdown menu of delivery services available for the particular shipment. For example, the delivery service level may be Next Day Air, Next Day Air Early AM, Next Day Air Saver, 2nd Day Air, 2nd Day Air Early AM, 3 Day Select, and/or Ground. Of course, other options from one or more carriers may be presented to the import entity for selection. For example, United Parcel Service™ may allow an import entity to select from Worldwide Express Plus, Worldwide Express, Worldwide Express NA1, Worldwide Express Saver, Worldwide Expedited, UPS 3 Day Select, and UPS Standard.

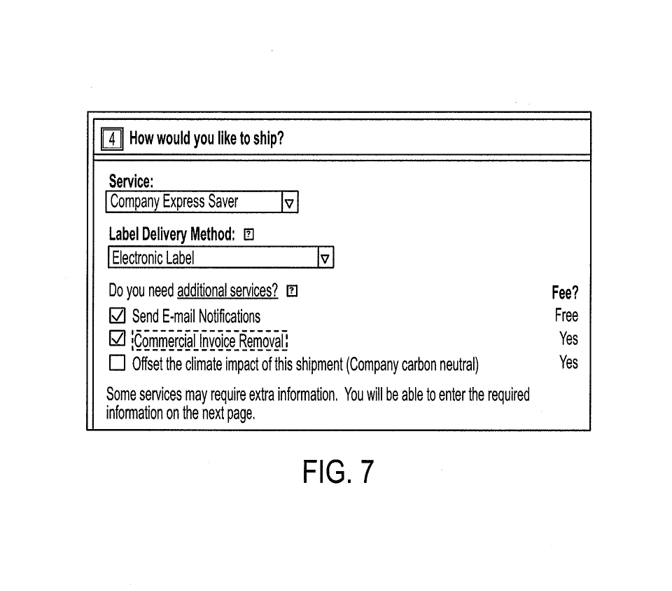

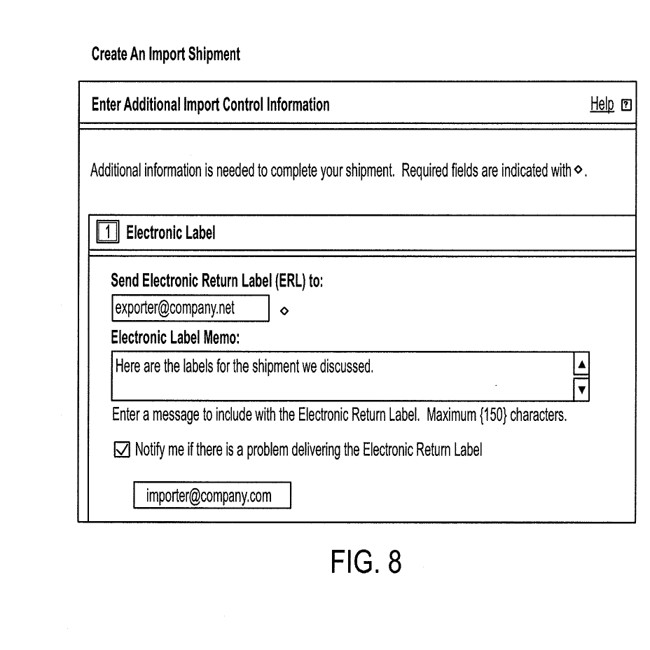

In various embodiments, the import entity may be able to select the mechanism used to deliver the shipping labels to the export entity (Block 230 in FIG. 3). The export entity may be an individual, a family, a company, an organization, an entity, a department within an organization, a representative of an organization and/or person, and/or the like seeking to sell or otherwise provide items across an international border. The import entity may be able to select (a) electronic labels or (b) physical labels. If electronic labels are selected, the import entity may be able to identify where the labels are to be sent. For example, the import entity (e.g., an import entity or an import entity representative operating an import entity computing device 100) may instruct the import control system to send electronic labels to the import entity for subsequent transmission by the import entity to the export entity or have the electronic labels sent directly to the export entity via email. For instance, as shown in FIGS. 7 and 8, an import entity (e.g., an import entity or an import entity representative operating an import entity computing device 100) may be provided (e.g., by the Import Control Module 800) an option of selecting from a dropdown menu of available label delivery methods. In the event an import entity elects to have an electronic label generated, the import entity, as illustrated in FIG. 8, may be prompted (e.g., by the Import Control Module 800) to enter an email address to which the labels are to be sent. The import entity may also be permitted to add a custom greeting to the email sent to the recipient of the labels.

In the event the import entity (e.g., an import entity or an import entity representative operating an import entity computing device 100) selects physical labels, the import control system and/or the carrier system may generate the labels and have an agent deliver the physical labels to the export entity. The delivery of the labels may be in conjunction with or prior to picking up the items for delivery to the destination address. This process is described in greater detail below.

In addition to service level and label delivery options, the import entity may also be given the opportunity to select ancillary services (Block 240 in FIG. 3). For instance, as shown in FIG. 7, the import entity may be presented the option of selecting services (e.g., by the Import Control Module 800) such as, for example, email notifications, commercial invoice removal, carbon neutral shipping (e.g., purchase carbon offsets) and unique shipment reference numbers (e.g., a purchase order number, item number) and the like.

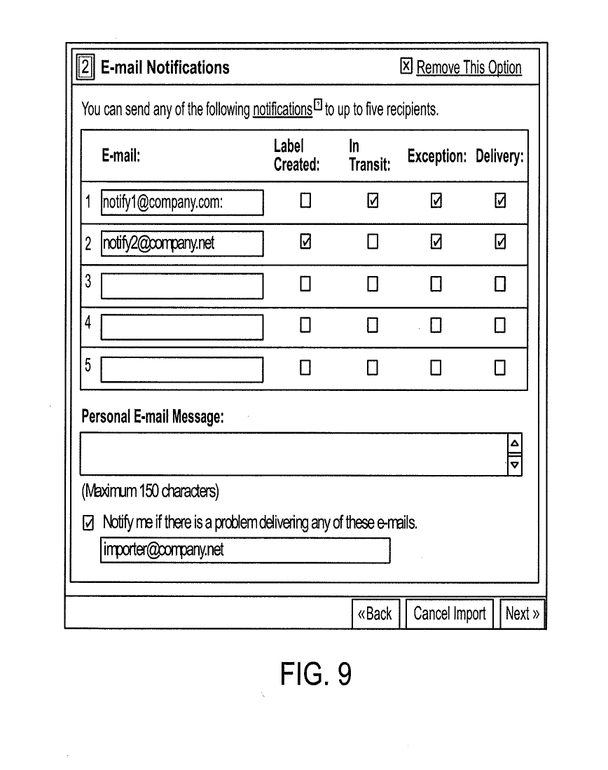

In the event the import entity selects an email notifications option, the import entity may be prompted (e.g., by the Import Control Module 800) to supply the email address to which the notifications are sent. For example, the import entity may elect to send notifications to one or more email address. In one embodiment, as shown in FIG. 9, a import entity (e.g., a import entity or a import entity representative operating a import entity computing device 100) may be afforded the opportunity (e.g., by the Import Control Module 800) to add multiple email address and identify which notifications are sent to which email addresses (e.g., label created, in transit, exception, and delivery notifications). The import entity may also add a personal message to accompany the email notification and may request to be notified if an email delivery problem arises.

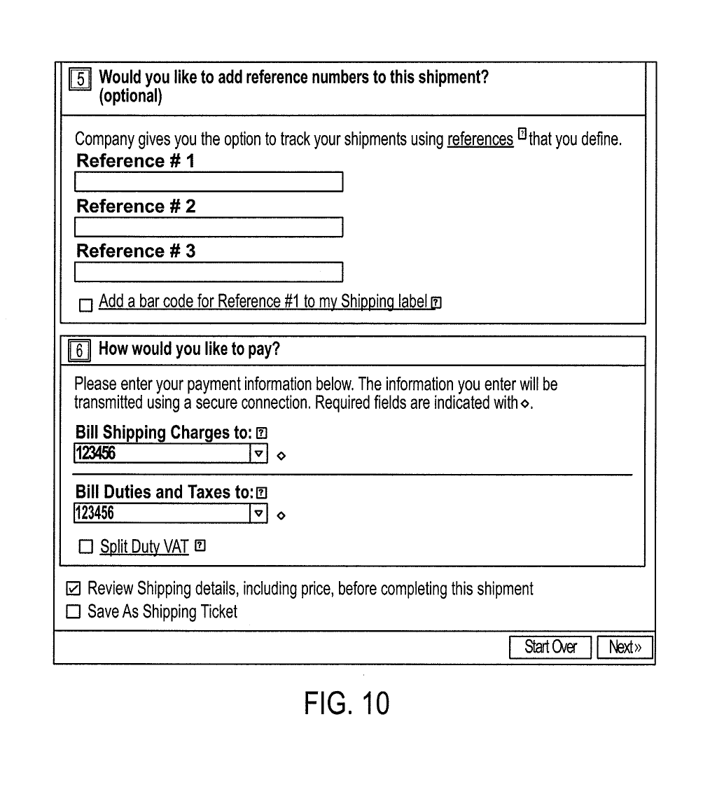

Although the carrier will likely assign a tracking number to the package being sent, the import entity may be provided an opportunity to add other reference numbers for inclusion on the shipping label. For example, an import entity (e.g., an import entity or an import entity representative operating an import entity computing device 100) may seek to include a purchase order number, item number or the like to the shipping label to further track the items being shipped. FIG. 10 illustrates an embodiment where the import entity is provided (e.g., by the Import Control Module 800) the opportunity to add up to three reference numbers. These numbers may be stored in a data repository in association with the shipping data in order to provide tracking data for the shipment. Of course, more or less than three reference numbers may be stored in association with the shipment data as desired. These numbers may be encoded and/or included on the shipping label as well as on the customers invoice.

After entering the shipment and delivery information, the import entity may be prompted to identify the payment method for the transportation charges, duties and any taxes that may be due (Block 250 of FIG. 3). In various embodiments, the import entity may be allowed to be charged to an existing account with the carrier or to a third party account number with the carrier. For instance, as shown in FIG. 10, the import entity may be presented (e.g., by the Import Control Module 800) with a dropdown menu listing account numbers pulled from the data repository that are associated with the import entity to which the charges for transportation, duties and taxes may be applied. The import entity (e.g., an import entity or an import entity representative operating an import entity computing device 100) would then select an account for the charges to be billed against. In further embodiments, an import entity may be provided the option to pay with a credit card, debit card, or other payment methods.

In addition to billing all freight, duties, and taxes to an import entity's account or a third party's account (or through other payment methods), various embodiments may provide the option to divide the charges between multiple accounts and/or parties. For example, an import entity may choose to have the shipping charges billed to one party and duties & taxes to another. Additionally, the import entity may elect to “Split Duty VAT” (SDV), as illustrated in FIG. 10, where an import entity may bill the freight & duty to one party and the tax/VAT to another party.

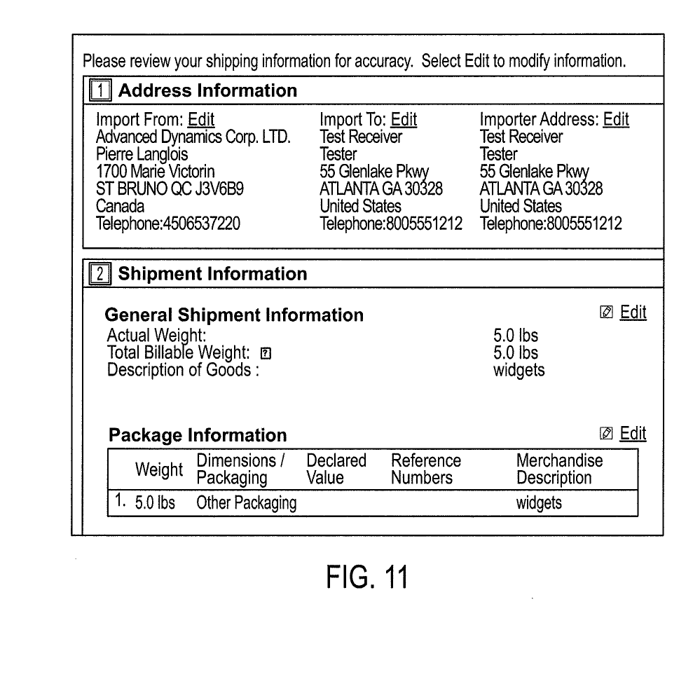

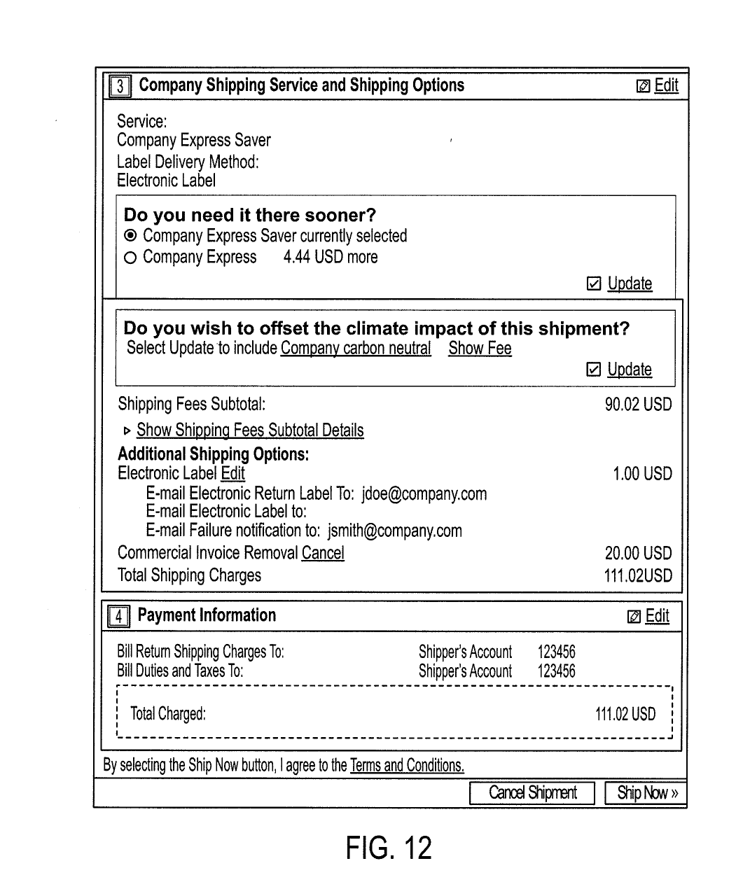

After the shipping, delivery and payment information is received by the import control system, a summary of the data entered may be provided to the import entity to verify the entered data with an opportunity to correct any inaccuracies. For instance, FIGS. 11 and 12 illustrate a possible format that the data may be presented to an import entity for verification.

### b. Export Forms Generation

As will be understood, international shipments require the generation of various documents to successfully cross an international border. One of the documents that is often required is a commercial invoice. A commercial invoice is generally a document that describes the shipment of items and shows information such as the import entity, the export entity, and the value of the shipment. Another common international shipping document used for cross-border shipments in North America is a NAFTA Certificate of Origin. In various embodiments, the import control system provides the option of the import entity to generate these and/or other export documents (e.g., via the Document Generation Module 900). Other documents that may be generated through the import control process are Certificate of Origin and Shipper's Export Declaration.

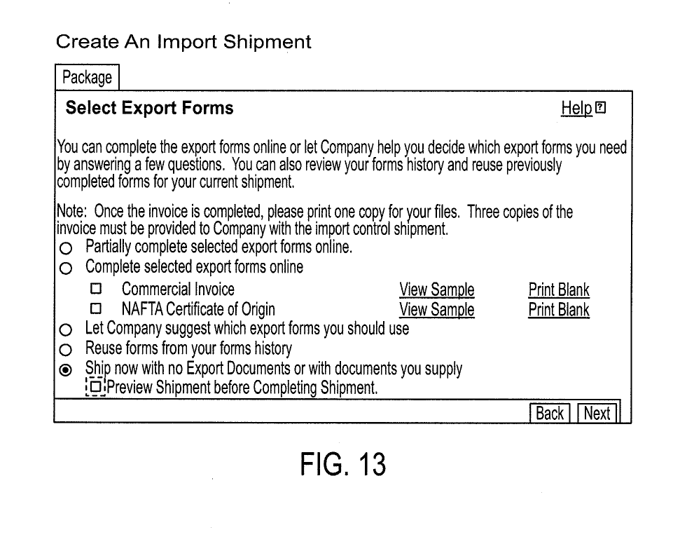

After the shipping, delivery and payment information is entered, the import control system may provide (e.g., via the Document Generation Module 900) the import entity with the option of generating a portion or a complete commercial invoice and/or other export documents (Block 260 in FIG. 3). For instance, as shown in FIG. 13, an import entity may elect to partially complete some or all of the necessary documents or complete the commercial invoice and/or the NAFTA Certificate of Origin. A further option is to allow the import control system to identify which documents are necessary for importing a particular item into a particular country as identified in the shipping information entered earlier base on a comparison with customs requirements for particular countries stored in the data repository. Further options, as illustrated in FIG. 13, may include using previous customs documents stored in the data repository for the particular import entity or not providing any export documents.

After the desired documents are identified, the import control system may use the information already entered by the import entity to pre-populate the various forms and then prompt the import entity to enter any missing information.

### c. Document Delivery

After the shipment is entered into the import control system and the necessary documents identified, the import control system generates the labels and the documents as identified by the import entity (e.g., an import entity or an import entity representative operating an import entity computing device 100). Once the documents have been generated, they may be disseminated according to the import entity's selections (Block 270 in FIG. 3).

In various embodiments, the import entity may have elected one of three possible delivery options (Block 300 in FIG. 4). One possible option is for the import control system to email an electronic version of the documents (e.g., PDF, DOC or other document format) to the import entity (Block 310). Another option is to provide a hyperlink to an electronic version of the labels and documents stored in a data repository. The hyperlink may be provided in an email as opposed to an electronic version of the documents. In either case, the import entity may email the electronic documents, the hyperlink, print/scan/email the scanned materials or otherwise send the labels and documents to the export entity (Block 315).

Another option that may be provided to the import entity is to have the import control system 120 and/or the carrier system 130 sends the labels and documents directly to the export entity (Block 320). As noted above, the import entity may identify an email address to which the labels and documents are to be sent. The import control system 120 and/or the carrier system 130 may email an electronic version of the documents (e.g., PDF, DOC or other document format) or provide a hyperlink to an electronic version of the documents stored in a data repository. The export entity may then print the labels and documents and prepare the items for shipment. In various embodiments, the documents may include instructions on how to prepare the items for shipment.

A further option is for the import control system and/or the carrier system to generate the labels and documents and have an agent deliver the labels and documents to the export entity (Block 325). In various embodiments, the carrier may print and deliver the labels and documents to the export entity themselves or by a third party.

In other embodiments, the delivery of the labels and documents may be done in conjunction with a pickup of the items for delivery to the destination address. In this case, the delivery driver may pickup the one or more packages housing the items and affix or otherwise associate the labels and documents with the one or more packages. In one embodiment, the delivery driver may make one attempt to retrieve the packages from the export entity and in the event the packages are not ready, the delivery driver may leave the labels and documents with the export entity. In which case, the export entity may reschedule the pickup or drop the packages off at a carrier location such as a retail shipping outlet or drop box.

In other embodiments, the carrier may dispatch a driver to the pickup location multiple times in an attempt to pickup the packages. For example, the carrier may dispatch a driver with the labels and documents to the pickup location to retrieve the items for shipment. If the items are not available for shipment on the first attempt, the carrier may dispatch the driver for a second attempt on the next business day. If the items are still not available, the carrier may make a third attempt on the next ensuing business day. In the event the third attempt is unsuccessful, the carrier may leave the labels and documents with the shipping entity to schedule a new pickup date or drop the packages at a drop off location associated with the carrier (e.g., drop box, shipping retail outlet). In other embodiments, the carrier may continue to make attempts to pickup the items without leaving the labels and documents. In still further embodiments, subsequent delivery attempts may be 2 or more days from the previous delivery attempt.

### d. Item Delivery

After the items are received by the carrier at Block 330, the items are transported to the destination address at Block 340. As will be understood, the items may pass through multiple hubs associated with the carrier in route to destination address. As the items pass through these hubs, tracking information reflecting the item's movement in the carrier's transportation network may be collected. To reflect the item's movement, an item/shipment identifier associated with the item may be scanned or otherwise electronically read at various points as the item is transported through the carrier's transportation network. For example, the item/shipment identifier may be automatically scanned by a barcode or Maxi Code device, an RFID interrogator, by a camera controller, or by a carrier employee using a handheld device. In one embodiment, each time the item/shipment identifier is scanned or read, an appropriate device can transmit the item/shipment identifier and other appropriate information (e.g., location and time of the scan or reading) to the carrier system 130. The carrier system 130 can then receive and use the information to track the item as it is transported though the carrier's transportation network and update the shipping data accordingly.

In the event the import entity elected to have the commercial invoice removed from the package before delivery to the destination address, the label itself or data associated with the items stored in the data repository may indicate the package should be held at a hub in the destination country. In response to an operator or system capturing information from the label in the destination country hub, the system may provide instructions to the operator to “hold” the item until the commercial invoice is removed. After the commercial invoice is removed, the operator may clear the “hold” thereby allowing delivery of the items to the final destination.

### e. Additional Embodiments

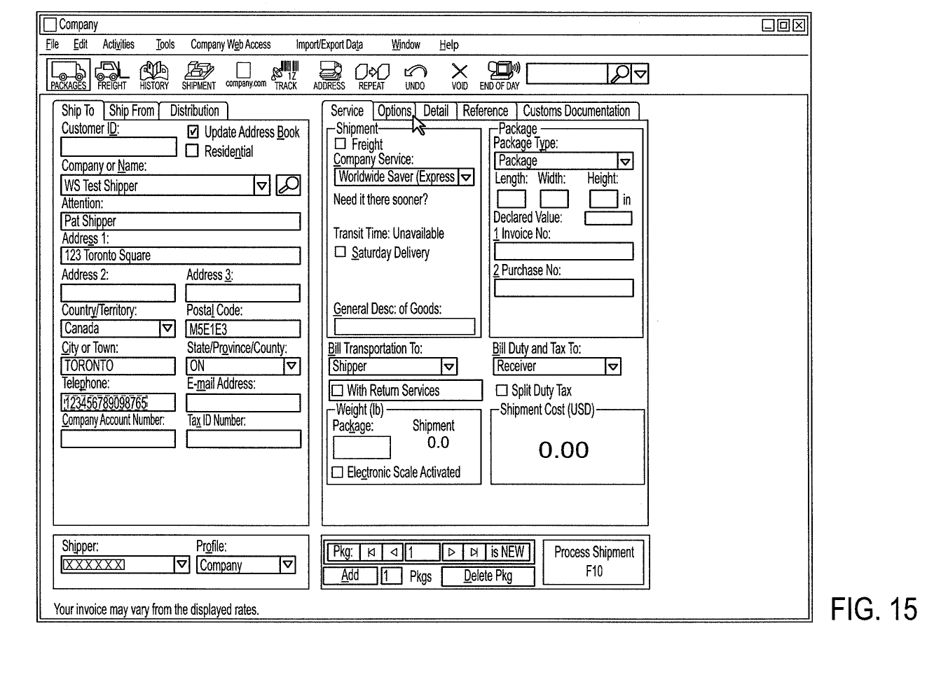

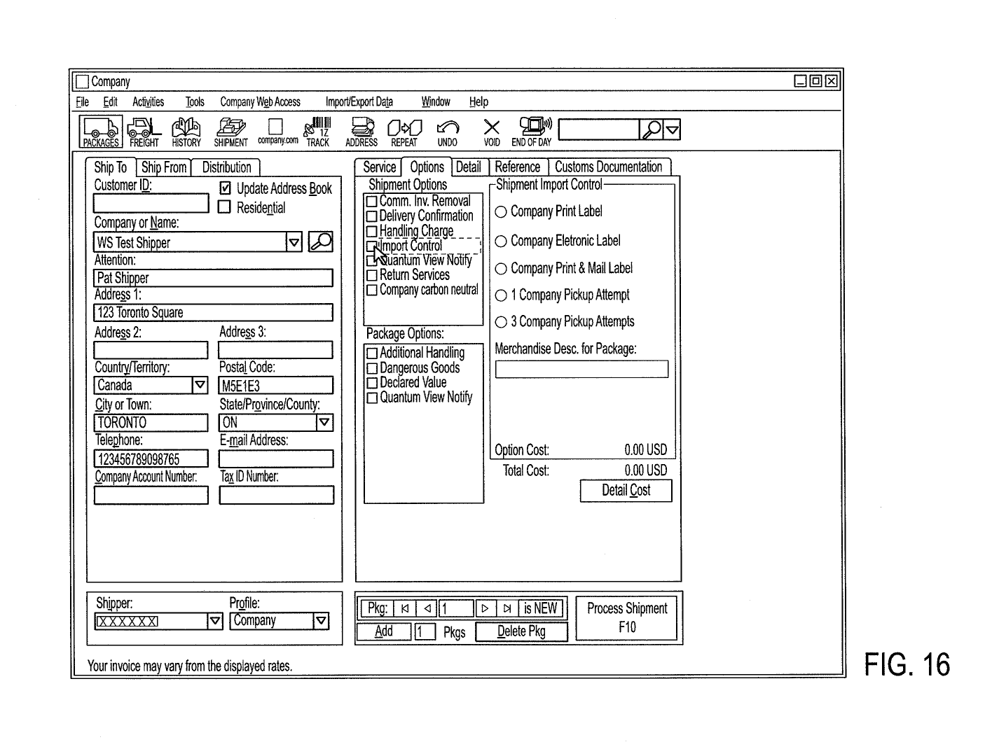

The forgoing paragraphs provide a description of embodiments of the present invention with reference to inputs and outputs illustrated in FIGS. 5-14. The following paragraphs also provide a description of embodiments of the present invention with reference to alternative inputs and outputs as illustrated in FIGS. 15-21. FIG. 16 illustrates a webpage with a series of text boxes for receiving shipping information. As illustrated, the webpage provides two groups of tabs. The first groups focuses primary on location information (e.g., Ship to, Ship from, Distribution) while the second group of tabs relates to service options (Service, Options, Detail, Reference, Customs Documentation). The import entity (e.g., an import entity or an import entity representative operating an import entity computing device 110 via the network 125) may selectively activate the various tabs and enter information as necessary to facilitate a shipment. It should be understood that this is a non-limiting embodiment and other embodiments may be organized in different ways.

The import control system provides an opportunity for the import entity to manually enter or retrieved address information from an address book for the various location tabs (e.g., Ship to, Ship from, Distribution). The address book information may be stored in the import or carrier system in association with the import entity (e.g., an import entity or an import entity representative operating an import entity computing device 110 via the network 125). For example, the address book may be accessed by activating the dropdown menu associated with the “Company or Name” text box.

To activate the import control option, the import entity (e.g., an import entity or an import entity representative operating an import entity computing device 110 via the network 125) selects the import control option under the “Options” tab (Block 210 of FIG. 3). In some embodiments, the import control system only offers the import control option if international addresses are entered. It should be understood that the import entity (e.g., an import entity or an import entity representative operating an import entity computing device 110 via the network 125) may enter shipment information (Block 220 of FIG. 3) prior to or after activating the import control process (Block 220 of FIG. 3). Additional options offered to the import entity (e.g., an import entity or an import entity representative operating an import entity computing device 110 via the network 125) (e.g., by the Import Control Module 800) may include commercial invoice removal, delivery confirmation, special handling, special notifications, return services and carbon neutral shipping, and/or collect-on-delivery.

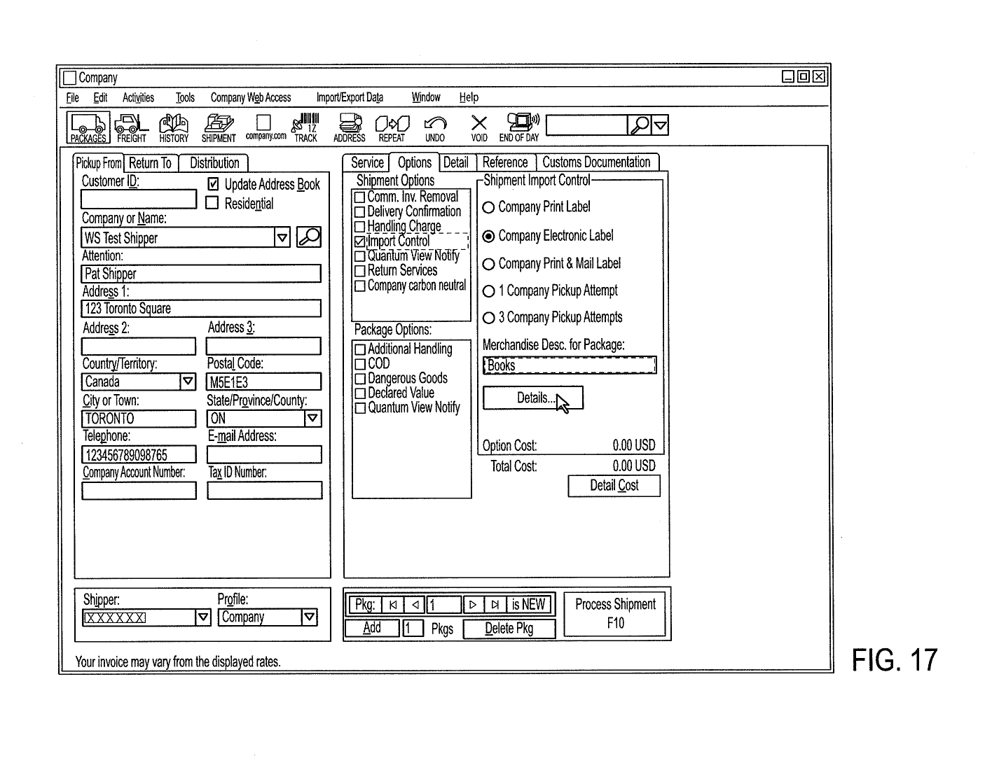

In the embodiment illustrated in FIG. 17, the “Ship To” tab and the “Ship From” changes to “Pickup From” and “Return To,” respectively, once the import entity (e.g., an import entity or an import entity representative operating an import entity computing device 110 via the network 125) selects import control.

After activating the import control process, the import entity (e.g., an import entity or an import entity representative operating an import entity computing device 110 via the network 125) may select a label delivery method and pickup options (Blocks 230 and 240 of FIG. 3). In this instance, as illustrated in FIG. 17, the import control system (e.g., by the Import Control Module 800) may provide a list of options from which to choose (e.g. Print Label, Electronic Label, Print & Mail, 1 Pickup Attempt, 3 Pickup Attempts). In addition, the import entity may be prompted (e.g., by the Import Control Module 800) to enter a merchandise description in an associated text box. The embodiment illustrated in FIG. 17 provides a different color box to prompt the user, but it should be understood that other known prompting techniques may be used to obtain a description of the merchandise.

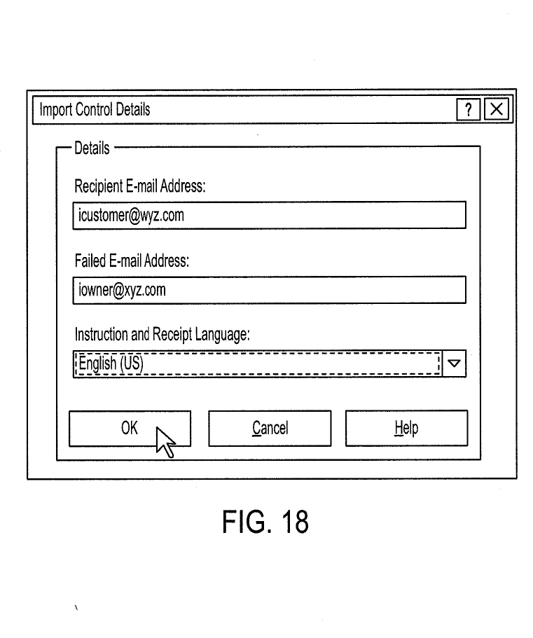

In the event the import entity (e.g., an import entity or an import entity representative operating an import entity computing device 110 via the network 125) selects electronic delivery of the label, the import control system may prompt (e.g., by the Import Control Module 800) the import entity (e.g., an import entity or an import entity representative operating an import entity computing device 110 via the network 125) to enter contact information for sending the labels. In one instance, the import entity (e.g., an import entity or an import entity representative operating an import entity computing device 110 via the network 125) may activate a button or select a tab (e.g., “Details” button or tab) and in response the import control system provides a window similar to that illustrated in FIG. 18. This window provides an opportunity to add (a) a primary email address, (b) a second email address for use in the event attempts to deliver the labels to the primary email fails. In some embodiments, the window may appear automatically (e.g., by the Import Control Module 800) in response to the import entity (e.g., an import entity or an import entity representative operating an import entity computing device 110 via the network 125) electing an electronic label delivery option.

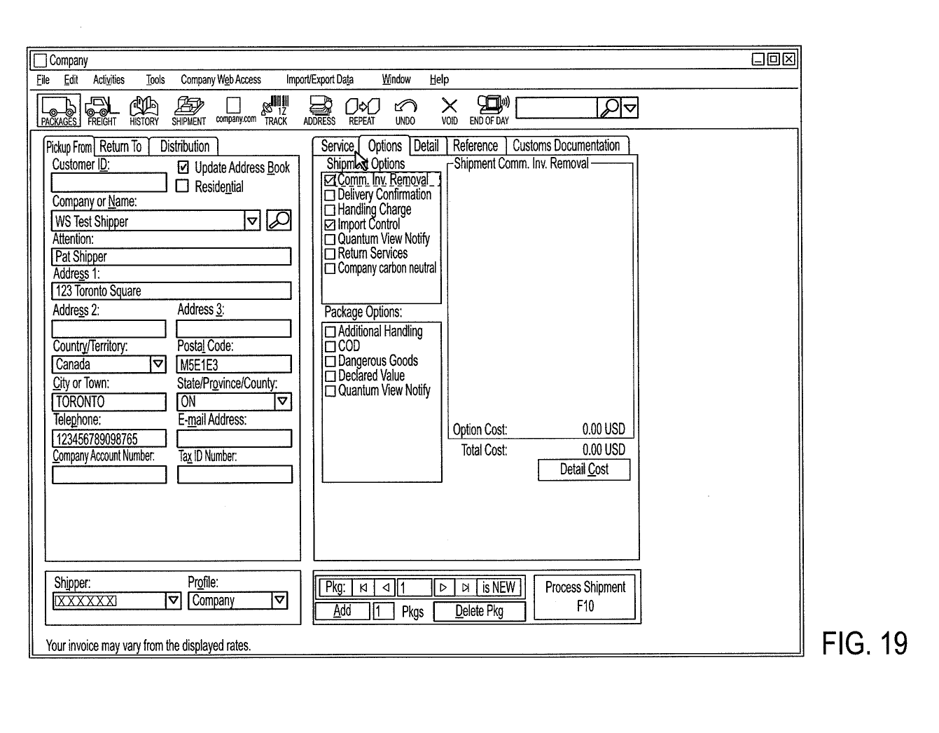

In addition to selecting label delivery options, the import entity (e.g., an import entity or an import entity representative operating an import entity computing device 110 via the network 125) may also be offered different service options. For example, FIG. 19 illustrates a webpage that may be provided (e.g., by the Import Control Module 800) that lists shipment and package options that may be selected by the import entity (e.g., an import entity or an import entity representative operating an import entity computing device 110 via the network 125). These options may include a service option such for example Next Day Air, Next Day Air Early AM, Next Day Air Saver, 2nd Day Air, 2nd Day Air Early AM, 3 Day Select, and/or Ground. Of course, other options from one or more carriers may be presented to the import entity for selection. For example, United Parcel Service™ may allow an import entity to select from Worldwide Express Plus, Worldwide Express, Worldwide Express NA1, Worldwide Express Saver, Worldwide Expedited, UPS 3 Day Select, and UPS Standard. Other options include Saturday deliver and delivery of documents only.

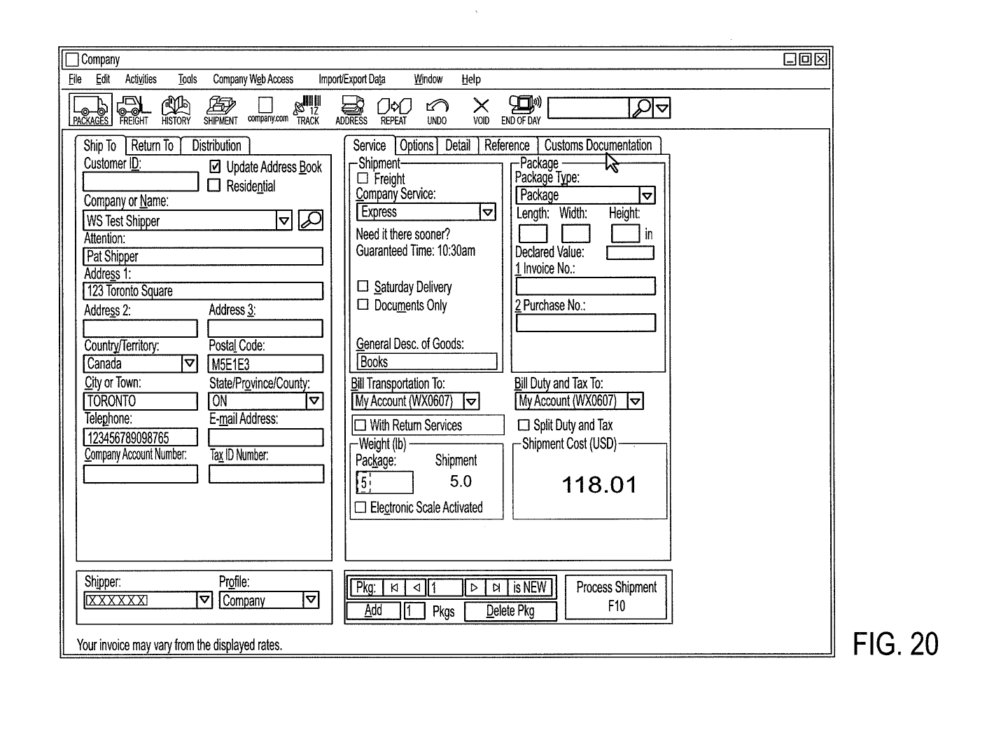

The webpage illustrated in FIG. 20 also provides an opportunity for the import entity (e.g., an import entity or an import entity representative operating an import entity computing device 110 via the network 125) to provide a payment method (Block 250 in FIG. 3). In this illustrated embodiment, the import entity (e.g., an import entity or an import entity representative operating an import entity computing device 110 via the network 125) is prompted (e.g., by the Import Control Module 800) to enter account numbers in the “Bill Transportation To:” and “Bill Duty and Tax To:” text boxes or dropdown menus. The import entity (e.g., an import entity or an import entity representative operating an import entity computing device 110 via the network 125) may also be given the opportunity to split the duty and tax amounts.

In addition to the entry of payment information, the output illustrated in FIG. 20 also allows entry of package information (Block 220 at FIG. 3). This information may include the package's weight and size.

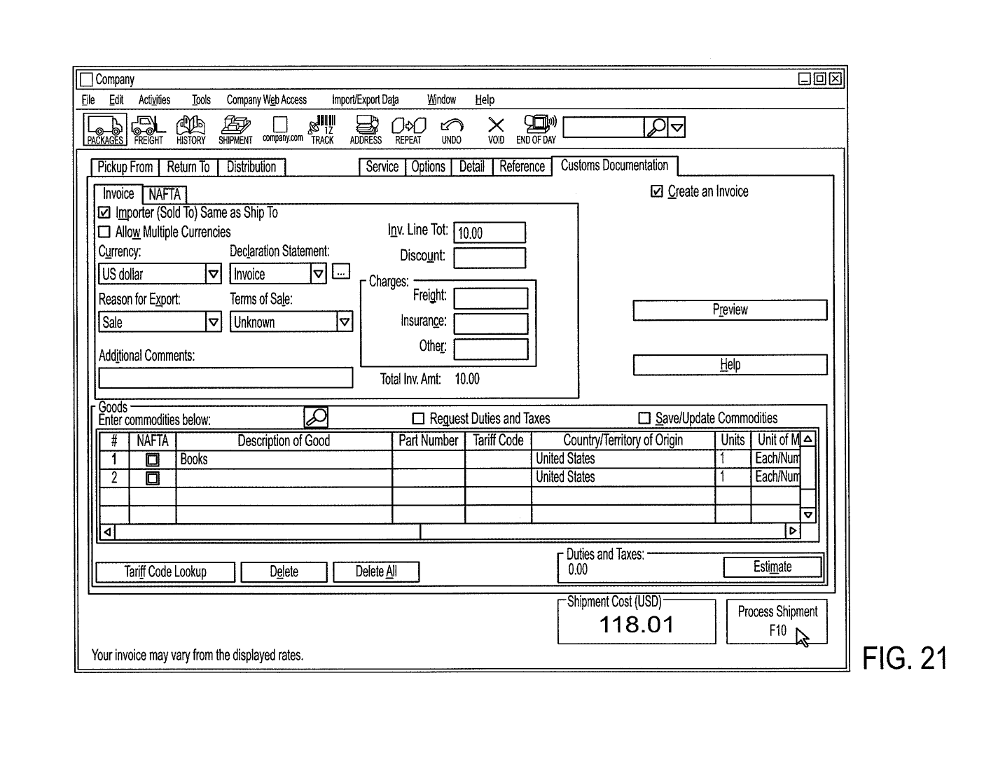

As will be understood, international shipments require the generation of various documents to successfully cross an international border. To facilitate preparation of these documents, the import control system (e.g., by the Import Control Module 800) may prompt the import entity (e.g., an import entity or an import entity representative operating an import entity computing device 110 via the network 125) to enter certain information such as currencies, reasons for export, terms of sale, tariff codes, etc. In one instance, FIG. 21 provides a series of text boxes and drop down menus to facilitate entry of this information.

Once the necessary information has been entered, the import control system may proceed with generation of the labels and associated documents (Block 260 in FIG. 3). In the embodiment shown in FIG. 21, the import entity (e.g., an import entity or an import entity representative operating an import entity computing device 110 via the network 125) activates the “Process Shipment” button to complete the process.

Once the “Process Shipment” button is activated, the import control system may stores the entered shipment data for transmission to the carrier. In some cases, the transmission may occur periodically (e.g., at the end of a day or shift). The import control system may allow an import entity to retrieve their stored data as desired.

### V. CONCLUSION

It should be understood that although the above description of an exemplary process discussed the import control system and the carrier system as different systems, it is contemplated that the functionality of the import control system could be incorporated into the carrier system.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for facilitating an international cross-border shipment from an exporting entity to an import entity, the method comprising:
receiving, via an import computer system, shipping data comprising a pickup location and a delivery location corresponding to an item to be delivered from an export entity to an import entity;
providing an interactive display to the import entity offering a plurality of label delivery options;
receiving a selection from the import entity of a select label delivery option;
generating a commercial invoice using at least in part the received shipping data; and
providing a label and the commercial invoice according to the select label delivery option.

2. The method of claim 1 further comprising the step of determining that the shipment will cross an international border based on a comparison between pickup location and a delivery location.

3. The method of claim 1, wherein the shipment comprises one or more packages and the shipment data comprises a weight and a size of the one or more packages that comprise the shipment.

4. The method of claim 1 further comprising the step of removing the commercial invoice from the shipment prior to delivery of the shipment to the import entity.

5. The method of claim 1 further comprising the step of receiving a first account number to bill transportation charges and receiving a second account number to bill taxes and duties associated with the shipment.

6. The method of claim 1, wherein the label delivery options are selected from the group consisting of: (a) delivery of an electronic label to the import entity, (b) delivery of an electronic label to the export entity and (c) delivery of a physical label to the export entity.

7. The method of claim 6, wherein the select label delivery option comprises delivery of a physical label to the export entity and the delivery is made in conjunction with the retrieval of the shipment from the export entity.

8. The method of claim 1, further comprising the step of prompting the import entity to enter an email address for delivery of the electronic label.

9. The method of claim 1 further comprising the steps of:
providing an interactive display offering a plurality of pickup options to an import entity;
receiving a selection from the import entity of a select pickup option;

10. The method of claim 1, wherein the plurality of pickup options comprises a single pickup attempt at the export entity and a plurality of pickup attempts at the export entity.

11. A system for facilitating an international cross-border shipment from an exporting entity to an import entity, the system comprising an import control system comprising one or more processors and one or more memory storage areas, wherein the carrier system is configured to:
receive shipping data comprising a pickup location and a delivery location corresponding to an item to be delivered to from an export entity to an import entity;
provide an interactive display to the import entity offering a plurality of label delivery options;
receive a selection from the import entity of a select label delivery option;
generate a commercial invoice using at least in part the received shipping data; and
provide a label and the commercial invoice according to the select label delivery option.

12. The system according to claim 11, wherein the import control computer system is further configured to determine that the shipment will cross an international border based on a comparison between a pickup location and a delivery location.

13. The system according to claim 11, wherein the shipment comprises one or more packages and the shipment data comprises a weight and a size of the one or more packages that comprise the shipment.

14. The system according to claim 11, wherein the import control computer system is further configured to provide instructions to remove the commercial invoice from the shipment prior to delivery of the shipment to the import entity.

15. The system according to claim 11, wherein the import control computer system is further configured to receive a first account number to bill shipping costs and receiving a second account number to bill taxes and duties associated with the shipment.

16. The system according to claim 11, wherein the label delivery options are selected from the group consisting of: (a) delivery of an electronic label to the import entity, (b) delivery of an electronic label to the export entity and (c) delivery of a physical label to the export entity.

17. The system according to claim 16, wherein the select label delivery option comprises delivery of a physical label to the export entity and the delivery is made in conjunction with the retrieval of the shipment from the export entity.

18. The system according to claim 11, wherein the import control computer system is further configured to prompt the import entity to enter an email address for delivery of the electronic label.

19. The system according to claim 11, wherein the import control computer system is further configured to:
provide an interactive display offering a plurality of pickup options to an import entity;
receive a selection from the import entity of a select pickup option;

20. The system according to claim 11, wherein the plurality of pickup options comprises a single pickup attempt at the export entity and a plurality of pickup attempts at the export entity.
